(19) United States
(12) Patent Application Publication
(10) Pub. No.: US 2015/0030088 A1
(43) Pub. Date: Jan. 29, 2015

(54) CLOCK RECOVERY FOR MEDIA STREAM IN BURSTY NETWORK CHANNEL

(71) Applicants: Vincent M. K. Chan, Richmond Hill (CA); Yimin Wang, Richmond Hill (CA)

(72) Inventors: Vincent M. K. Chan, Richmond Hill (CA); Yimin Wang, Richmond Hill (CA)

(73) Assignee: VIXS SYSTEMS INC., Toronto (CA)

(21) Appl. No.: 14/089,701

(22) Filed: Nov. 25, 2013

Related U.S. Application Data
(60) Provisional application No. 61/858,756, filed on Jul. 26, 2013.

(51) Int. Cl. H04N 19/86; H04N 19/70

(52) U.S. Cl. CPC H04N 19/00909; H04N 19/00884
USPC 375/240.28

(57) ABSTRACT

A media processing device includes a transmission interface to transmit an output media stream based on an output clock signal, whereby output video stream includes a representation (e.g., a transcoded representation) of an input media stream. The media processing device further includes a clock drift module to generate a stream of average clock drift values representing differences between a local system time clock and clock references of the input media stream and a proportional-integral-derivative (PID) controller to filter the stream of average clock drift values to generate a stream of filtered average clock drift values. The media processing device further includes a clock adjust module to adjust the output clock signal based on the stream of filtered average clock drift values.

### CROSS-REFERENCE TO RELATED APPLICATIONS

The present application claims priority to U.S. patent application Ser. No. 61/858,756, entitled “CLOCK RECOVERY FOR MEDIA STREAM IN BURSTY NETWORK CHANNEL” and filed on Jul. 26, 2013, the entirety of which is incorporated by reference herein.

### FIELD OF THE DISCLOSURE

The present disclosure generally relates to media processing and, more particularly, to clock recovery for clocking media stream transmissions.

### BACKGROUND

Media processing protocols, such as the Motion Pictures Experts Group-2 (MPEG2) (or ISO/IEC 13818-1) transport stream specification, and the H.264 (or Advanced Video Coding) specification, typically provide for a specific timing model for the sampling, encoding, encoder buffering, transmission, reception, decoder buffering, decoding, and presentation of digital audio and video (individually or collectively, “media”). In many media systems, this timing model provides for a clock recovery mechanism whereby a media source inserts clock references, such as program clock references (PCRs), for its system time clock into the media transport stream, and the transcoding system recovers the system time clock from these PCRs. The recovered system time clock then may be used for controlling the timing of a transcoding/encoding/decoding process, to control the transmission of a transcoded video stream to a downstream recipient via a transmission interface, and the like.

In many instances, the media transport stream is transmitted via a network with considerable jitter. This network jitter can introduce significant drift between the source system time clock and the recovered system time clock, and thus significantly impact the timing accuracy of the transcoder relying on the recovered system time clock for transcoding operations and the timing accuracy of the transmission interface providing for the transmission of the transcoded media stream to a downstream destination (e.g., a storage device, a display device, etc.).

### BRIEF DESCRIPTION OF THE DRAWINGS

The present disclosure may be better understood, and its numerous features and advantages made apparent to those skilled in the art, by referencing the accompanying drawings.

FIG. 1 is a block diagram illustrating a media system employing a proportional-integral-derivative (PID)-based clock recovery mechanism in accordance with at least one embodiment of the present disclosure.

FIG. 2 is a flow diagram illustrating a method for clock recovery using PID filtering at a media processing device of the media system of FIG. 1 in accordance with at least one embodiment of the present disclosure.

### DETAILED DESCRIPTION

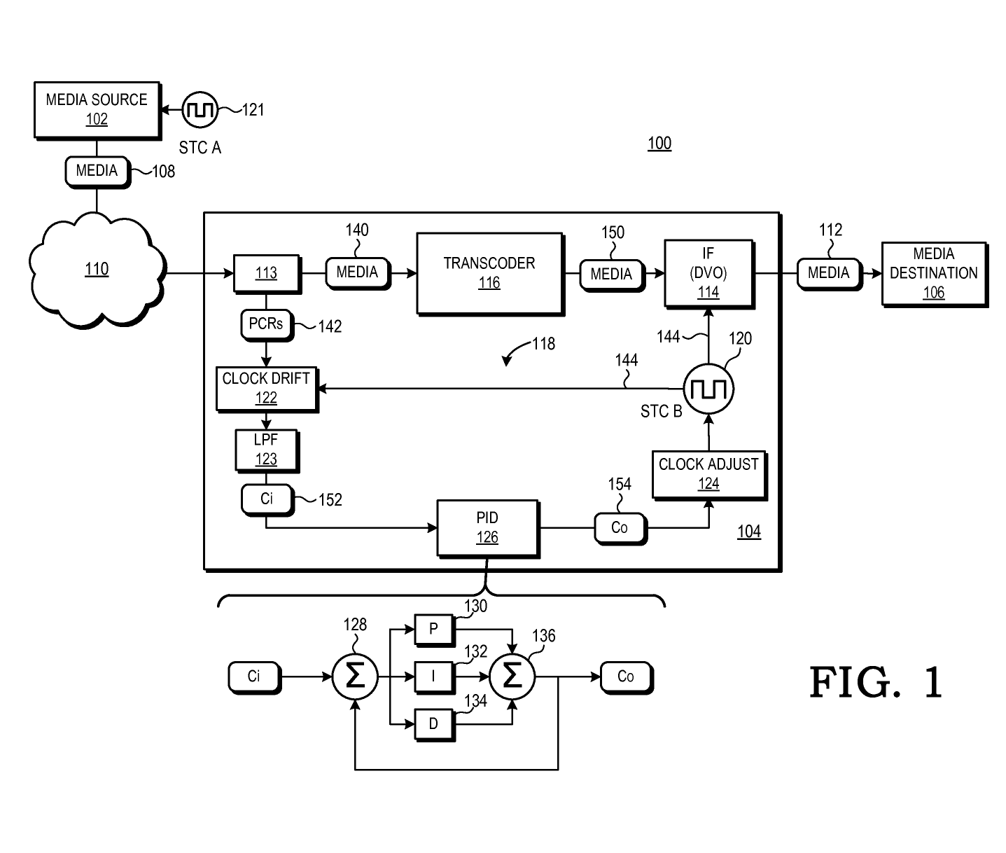

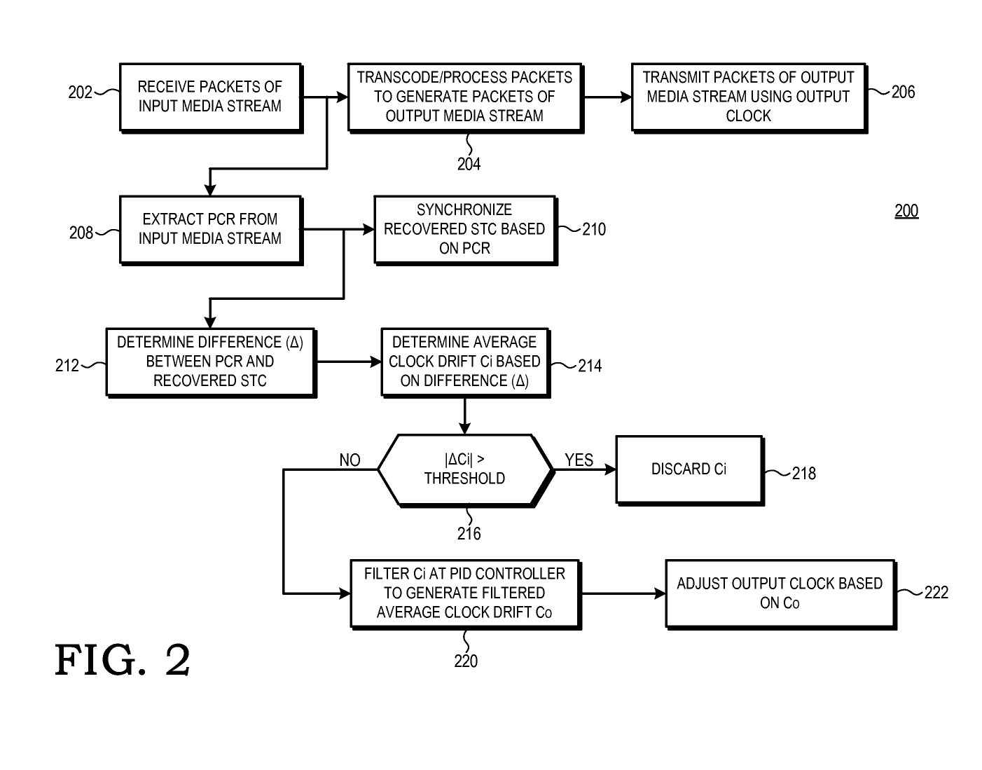

FIGS. 1 and 2 illustrate example techniques for clock recovery in a media system based on proportional-integral-derivative (PID) filtering of clock drift between a reference system time clock and a recovered system time clock. In at least one embodiment, a media source encodes a media stream with clock references based on a reference system time clock of the media source and transmits the media stream to a media processing device via a bursty network. The media processing device employs a clock recovery mechanism to recover a system time clock based on the clock references embedded in the media stream. The recovered system time clock then is used to control the timing of the media-processing-related components of the media processing device, such as, for example, a transcoder or other media processing component that processes the received media stream to generate an output media stream for downstream transmission. However, the bursty nature of the network between the media source and the media processing device can cause measurable drift between the original system time clock and the recovered system time clock, and this clock drift can negatively impact the ability of the media processing component and the transmission interface to meet the strict timing requirements of the applicable media processing standard. Accordingly, in at least one embodiment, the clock recovery mechanism employs a proportional-integral-derivative (PID) controller to filter or otherwise average or smooth this clock drift, and the resulting filtered clock drift is then used to adjust the recovered system time clock or to adjust a timing reference based on the recovered system time clock and used by the transmission interface. Under this approach, the reference clock signal in a media transport stream transmitted over a bursty network can be recovered for implementation in a media processing device in which the output clock rate is required to be tightly synchronized with the input rate.

For ease of illustration, the techniques of the present disclosure are described in the example context of generation of the output media stream based on generation of a transcoded representation of the input, or received, media stream based on, for example, the ISO/IEC 13818-1 specification, which is also commonly referred to as the MPEG-2 specification. However, the techniques of the present disclosure are not limited to this context, but instead may be implemented in any of a variety of block-based video compression techniques that employ clock recovery, examples of which include the MPEG-4 specification and the ITU-T H.263 and ITU-T H.264 specifications, as well as any of a variety of other non-transcoding media stream processing contexts, such as a format conversion context, a deinterlacing or scaling context, and the like.

FIG. 1 illustrates, in block diagram form, a media system 100 in accordance with at least one embodiment of the present disclosure. The media system 100 includes a. media source 102, a media processing device 104, and a media destination 106. The media system 100 can represent any of a variety of media systems in which encoding or transcoding of video and audio (individually or collectively, “media”) can be advantageously used. In one embodiment, the media system 100 is a distributed television system whereby the media source 102 comprises a terrestrial, cable, or satellite television broadcaster, an over-the-top (OTT) media source or other Internet-based media source, and the like. In this implementation, the media processing device 104 and the media destination 106 together are implemented as user equipment, such as a set-top box, a tablet computer or personal computer, a computing-enabled cellular phone, and the like. Thus, the media processing device 104 transcodes or otherwise processes an input video stream to generate an output video stream and the resulting output video stream is buffered or otherwise stored in a cache, memory, hard drive or other storage device (embodiments of the media destination 106) until it is accessed for decoding and display by a display device. As another example, the media system 100 can comprise a media content server system, whereby the media source 102 comprises one or more hard drives or other mass-storage devices storing original video content, the media destination 106 is a remote computer system connected to the media content server via a network, and the media processing device 104 is used to transcode the media content responsive to current network conditions before the transcoded media content is transmitted to the remote computer system via the network. As noted above, the techniques of the present disclosure will be described in an example transcoding context, and thus the output media stream is also referred to herein as the “transcoded media stream.” However, these techniques are not limited to a transcoding implementation, and instead may be implemented in other media processing contexts using the guidelines provided herein. Thus, reference to a “transcoding” and its variants equally applies to other media processing techniques unless otherwise noted.

In the illustrated embodiment, the media processing device 104 includes interfaces 113 and 114, a transcoder 116 (or other media processing component), and a clock synchronization controller 118. The interfaces 113 and 114 include interfaces used to communicate signaling with the media source 102 and the media destination 106, respectively. Examples of the interface 113 include input/output (I/O) interfaces, such as Peripheral Component Interconnect Express (PCIE), Universal Serial Bus (USB), Attached Technology Attachment (SATA), wired network interfaces such as Ethernet, or wireless network interfaces, such as IEEE 802.11x or Bluetooth(™) or a wireless cellular interface, such as a 3GPP, 4G, or LTE cellular data standard. Examples of the interface 114 include, for example, I/O interfaces such as the aforementioned PCIE, USB, SATA interfaces, a digital video out (DVO) interface, an asynchronous serial interface (ASI), and the like. The clock synchronization controller 118 includes a system time clock module 120, a clock drift module 122, a low pass filter (LPF) 123, a clock adjust module 124, and a proportional-integral-derivative (PID) controller 126. The transcoder 116 and clock synchronization controller 118 each may be implemented entirely in hard-coded logic (that is, hardware), as a combination of software stored in a non-transitory computer readable medium (e.g., memory, hard drive, or optical disc storage) and one or more processors to access and execute the software, or as combination of hard-coded logic and software-executed functionality. To illustrate, in one embodiment, the media processing device 104 is implemented as a system on a chip (SOC) whereby portions of the transcoder 116 and the clock synchronization controller 118 are implemented as hardware logic, and other portions are implemented via firmware stored at the SOC and executed by a processor of the SOC.

The hardware of the media processing device 104 can be implemented using a single processing device or a plurality of processing devices. Such processing devices can include a central processing unit (CPU), a graphics processing unit (GPU), a microcontroller, a digital signal processor, a field programmable gate array, programmable logic device, state machine, logic circuitry, analog circuitry, digital circuitry, or any device that manipulates signals (analog and/or digital) based on operational instructions that are stored in a memory. The memory may be a single memory device or a plurality of memory devices. Such memory devices can include a hard disk drive or other disk drive, read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

As a general operational overview, the media source 102 transmits or otherwise provides an input media stream 108 to the media processing device 104 via one or more networks 110. The network 110 can comprise, for example, a cellular data network, a wireless network (e.g., a wireless local area network (LAN)), a wide area network (WAN), the Internet, and the like. The input media stream 108 is transmitted in either an analog format, such as a National Television System Committee (NTSC) or Phase Alternating Line (PAL) format, or a digital format, such as an H.263 format, an H.264 format, a Moving Picture Experts Group (MPEG) format (such as MPEG1, MPEG-2 or MPEG4), QuickTime format, Real Media format, Windows Media Video (WMV) or Audio Video Interleave (AVI), or other digital video format, either standard or proprietary. In instances whereby the input media stream 108 has an analog format, the media processing device 104 operates to encode the input media stream 108 to generate an encoded video stream, and in instances whereby the input media stream 108 has a digital format, the media processing device 104 operates to transcode the input media stream 108 to generate a transcoded media stream 112. For purposes of illustration, the latter transcoding scenario is used as the primary exemplary embodiment herein, but the techniques described herein can be similarly implemented for encoding implementations, scaling implementations, or other media processing implementations. After encoding, the resulting transcoded media stream 112 is transmitted to the media destination 106, which can operate to one or more of store, decode, and display the transcoded media stream 112.

In the process of providing the input media stream 108, in one embodiment, the media source 102 encodes or otherwise formats the input media stream 108 to include periodic clock references corresponding to a current time reference from a reference system time clock 121 (also identified herein as “STC A”) of the media source 102. To illustrate, in an MPEG-2 implementation, the clock reference indicators can comprise, for example, program clock references (PCRs) inserted every 100 milliseconds ms) into the transport stream layer of the input media stream 108, wherein the PCRs comprise a 42 bit value corresponding to the counter-based value of the reference system time clock 121, with the first 32 bits based on a 90 kilohertz (90 kHz) clock of the reference system time clock 121 and the final 9 bits based on a 27 Megahertz (MHz) clock of the reference system time clock 121. MPEG 4, AVC, H.264, and other media processing standards describe a similar clock reference indicator scheme, and thus a non-limiting PCR implementation is described herein for sake of clarity.

Thus, the input media stream 108, as transmitted via the network 110, comprises a stream of media content packets 140 and a stream of control packets, including a stream of PCRs 142. As the interface 113 receives the input media stream 108, the interface 113 directs the stream of media content packets 140 to the transcoder 116 for transcode processing, and directs the stream of PCRs 142 to the clock synchronization controller 118. The system time clock module 120 includes a clock source (not shown) and uses the stream of PCRs 142 to perform a coarse synchronization of a system time clock 144 (also referred to herein as “STC B”) to the reference system time clock 121 using any of a variety of well-known clock recovery techniques, such as through the use of a phase-locked loop (PLL) that is coarsely adjusted based on the PCRs. That is, the system time clock module 120 uses the PCRs 142 to “recover” the reference system time clock 121 used to encode the input media stream 108 as the recovered system time clock 144 (e.g., synchronize STC B to STC A). The recovered system time clock 144 generated by the system time clock module 120 then is used to clock the transmission of a transcoded media stream 150 from the transcoder 116 to the media destination 106. Accordingly, the recovered system time clock 144 is also referred to herein as the “output clock signal 144”.

In many implementations, the network 110 may be significantly “bursty,” that is, exhibit significant jitter in the transmission of the packets of the input media stream 108 from the media source 102 to the media processing device 104. Consequently, there may be significant jitter introduced into the arrival of the PCRs 142, and this jitter in the PCRs 142 can cause significant drift in the system time clock 144 relative to the reference system time clock 121. This drift can negatively impact the timing of the transcoder 116 and, in particular, can severely impact the proper timing at the transmission interface 114, even to the point that the transmission interface 114 may violate the strict timing requirements specified by the applicable media transmission standard (e.g., MPEG-2).

To reduce or eliminate the impact of network jitter on accurate clock recovery at the media processing device 104, in at least one embodiment the clock synchronization controller 118 implements a fine-grained system time clock adjustment mechanism in the form of the clock drift module 122, the LPF 123, the PID controller 126, and the clock adjust module 124. As described in greater detail below with reference to FIG. 2, the fine-grained system time clock adjustment mechanism operates by finely-tuning the system time clock 144 based on a PID-filtered average of the clock drift between the recovered system time clock 144 and the reference system time clock 121. To this end, as the PCRs 142 are received, they are temporarily buffered at the clock drift module 122. From the buffered PCRs 142, the clock drift module generates a stream of average clock drill values 152 (also denoted as “average clock drift value Ci”), each average clock drift value 152 representing a moving average of the clock drift between the reference system time clock 121 as represented by the buffered PCRs 142 and the recovered system time clock 144 (that is, the difference between STC A and STC B). This stream of average clock drift values 152 may be filtered by the LPF 123 to remove those clock drift values 152 that exhibit a change from the previous clock drift value 152 that is greater than a predefined threshold (that is, Δclock_drift>threshold) on as to avoid negatively impacting the PID controller 126 with clock drift shifts resulting from instances of excessively large jitter. The resulting stream of average clock drift values 152 is fed to the PID controller 126, which filters the stream of average clock drift values 152 to generate a stream of filtered average clock drift values 154. As the recovered system time clock 144 (also referred to herein as the “output clock signal 144”) exhibits drift relative to the reference system time clock 121, in at least one embodiment, the clock adjust module 124 then uses the stream of filtered average clock drift values 154 to continuously make fine-grained adjustments to the output clock signal 144. To illustrate, the clock adjust module 124 may comprise a PLL that generates the output clock signal 144, and the PLL may take as an adjustment input each filtered average clock drift value 154 and tune the frequency of the output clock signal 144 based on the magnitude and sign of the filtered average clock drift value 154.

FIG. 2 illustrates an example method 200 for the fine-grained adjustment of the output clock signal 144 at the media processing device 104 of FIG. 1 in accordance with at least one embodiment. The method 200 initiates at block 202, whereby the media processing device 104 begins receiving packets of the input media stream 108 via the network 110. As these packets are received, at block 204 the interface 113 provides the media content and control information from the packets to the transcoder 116, which transcodes the media content to generate corresponding packets of the transcoded media stream 150. After each packet of the transcoded media stream 150 is output by the transcoder 116, at block 206 the transmission interface 114 transmits the packet to the media destination 106 as part of the output media stream 112. The operation of the transmission interface 114 is clocked by the output clock signal 144 provided by the system time clock module 120.

Concurrent with the transcoding of the packets of the input media stream 108, at block 208 the interface 113 extracts each PCR 142 as it is received as part of the transport stream of the input media stream 108 and provides the PCR 142 to the clock synchronization controller 118. At block 210, the system time clock module 120 uses the PCR 142 to provide a coarse-grained adjustment to the output clock signal 144 based on the difference between the PCR value and the current value of the output clock signal 144. That is, each PCR 142 serves to coarsely adjust the frequency of the output clock signal 144, and thus the PCRs 142 serve to synchronize, or “recover”, the reference system time clock 121 at the media processing system 104 as the output clock signal 144. Any of a variety of well-known PCR clock recovery techniques may be used in this regard.

As noted above, the network jitter of the network 110 introduces jitter in the stream of PCRs 142 in the input media stream 108, and thus the coarse-grained tuning of the output clock signal 144 based on the PCRs 142 may not be sufficient to maintain the tight timing synchronization requirements. Accordingly, in parallel with the coarse-grained tuning, the clock synchronization controller 118 employs the PID controller-based fine-grained tuning of the output clock signal 144 to compensate for such network jitter. To this end, at block 212 as each PCR 142 is received it is temporarily buffered at the clock drift module 122, and the clock drift module 122 determines a corresponding average clock drift value for the PCR 142; that is, the difference between the PCR 142 and the corresponding current value of the output clock signal 144. For this purpose, the clock drift module 122 may maintain, for example, a first-in first-out (FIFO) buffer to maintain a fixed maximum number of average clock drift values determined in this manner. Thus, once the FIFO buffer is filled with average clock drift values, the insertion of a newly calculated average clock drift value for a newly-received PCR 142 causes expulsion of the oldest average clock drift value from the FIFO buffer. In this manner, the FIFO buffer acts as a moving window of average clock drift values.

With the average clock drift value for the received PCR 142 calculated and inserted into the FIFO buffer, at block 214 the clock drift module 122 calculates an average clock drift value, denoted “Ci”, from a moving window (that is, from the average clock drift values currently in the FIFO buffer). This average can comprise, for example, an unweighted average or a weighted average that places, for example, more weight on more recent average clock drift values. Thus, it will be appreciated for each new PCR 142 received, a corresponding new clock drift value is inserted into the FIFO buffer and thus the clock drift module 122 calculates anew average clock drift value Ci. That is, the clock drift module 122 generates a stream of average clock drift values Ci based on a moving-window averaging of clock drift values representing differences between corresponding PCRs 142 and corresponding values of the output clock signal 144.

While the average clock drift value Ci can be a relatively accurate reflection of a correction needed for the output clock signal 144 to more completely synchronize with the reference system time clock 119 of the media source 102, adjustment of the output clock signal 144 directly from the average clock drift value Ci can introduce undesirable perturbations into to the output clock signal 144, such as hysteresis or overly-aggressive correction to the output clock signal 144 due to a very temporary delay in PCRs 142 over the network 110. Accordingly, to effect a smoother correction of the recovered system time clock 144 to correct for clock drift due to PCR jitter over the network 110, in at least one embodiment, the RID controller 126 is used to performing a smoothing filter function for the stream of average clock drift values 152. This smoothing filter function is illustrated via blocks 216, 218, 220, and 222.

In some instances, the average clock drift value may momentarily spike due to, for example, a temporary network congestion issue or other very temporary condition. To avoid having such large momentary perturbations from disproportionally influencing the fine-grained adjustment of the output clock signal 144, at block 216 the LPF 123 pre-filters each average clock drift value Ci before providing it to the PID controller 126 by comparing the change between the clock drift value Ci and the previous clock drift value Cᵢ₋₁ (that is, |ΔCi|) with a predefined threshold set by a developer or other user based on, for example, simulation or experimental evaluation. In the event that the magnitude of this change in clock drift exceeds this predefined threshold, at block 218 the LPF 123 discards the average clock drift value Ci or otherwise omits the average clock drift value Ci from the PID filtering process. Otherwise, if the change in average clock drift value falls below this predetermined threshold, at block 220 the LPF 123 provides the average clock drift value Ci to the PID controller 126, which then incorporates the average clock drift value Ci into the RID filtering process to generate a corresponding filtered average clock drift value Co, and at block 222 the clock adjust module 124 adjusts the output clock signal 144 based on the filtered average clock drill, value Co.

The filtering process of the PID controller 126 to generate the filtered average clock drift values Co is described with reference to the example configuration depicted in FIG. 1. As an average clock drift value Ci is generated, it is provided to the sum stage 128, whereupon the difference between the average clock drift value Ci and the previous filtered average clock drift value Co (or 0 if there are no previous filtered average clock drift values) is calculated by the sum stage 128. This calculated difference is then provided to each of the proportional stage 130, the integral stage 132, and the differential stage 134. The proportional stage 130 calculates a proportional component based on a multiplication of the average clock drift value Ci by a proportional gain value Kp. The proportional component thus can be viewed as primarily reflective of the immediate impact of the average clock drift value Co. The integral stage 132 calculates an integral component based on an integration of the average clock drift value Ci and previous average clock drift values Ci multiplied by an integral gain Ki. The integral component thus can be viewed as reflective of accumulated clock drift errors from the past. The derivative stage 134 calculates a derivative component based on a derivation of the current and previous average clock drift values Ci multiplied by a derivative gain Kd. The derivative component thus can be viewed as reflective of the rate of change in the average clock drift values Ci, and thus predictive of future changes in the average clock drift values Ci. Accordingly, the sum stage 136 sums the proportional component, the integral component, and the derivative component to generate the corresponding filtered average clock drift value Co, which is then used for clock signal adjustment as noted above, as well as fed back as an input to the sum stage 128 for the next cycle of filtering. In this manner, the PID controller 126 can smooth transitions in the average clock drift values Ci in a manner that both reflects the past and anticipates the future values, and thus can avoid undesirable artifacts such as hysteresis and excessive abrupt changes in the output clock signal 144.

In some embodiments, certain aspects of the techniques described above may implemented by one or more processors of a processing system executing software. The software comprises one or more sets of executable instructions stored or otherwise tangibly embodied on anon-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

In this document, relational terms such as “first” and “second”, and the like, may be used solely to distinguish one entity or action from another entity or action without necessarily requiring or implying any actual relationship or order between such entities or actions or any actual relationship or order between such entities and claimed elements. The term “another”, as used herein, is defined as at least a second or more. The terms “including”, “having”, or any variation thereof, as used herein, are defined as comprising.

Other embodiments, uses, and advantages of the disclosure will be apparent to those skilled in the art from consideration of the specification and practice of the disclosure disclosed herein. The specification and drawings should be considered as examples only, and the scope of the disclosure is accordingly intended to be limited only by the following claims and equivalents thereof.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A media processing device comprising:
a transmission interface to transmit an output media stream based on an output clock signal, the output media stream comprising a representation of an input media stream;
a clock drift module to generate a stream of average clock drift values representing differences between a local system time clock and clock references of the input media stream;
a proportional-integral-derivative (PID) controller to filter the stream of average clock drift values to generate a stream of filtered average clock drift values; and
a clock adjust module to adjust the output clock signal based on the stream of filtered average clock drift values.

2. The media processing device of claim 1, wherein the input media stream comprises a Motion Pictures Experts Group (MPEG)-based transport stream and the clock references comprises program clock references (PCRs).

3. The media processing device of claim 2, wherein the transmission interface comprises at least one of a digital video out (DVO) interface and an asynchronous serial interface (ASI).

4. The media processing device of claim 1, wherein the clock drift module provides the stream of average clock drift values as moving averages of the differences between the system time clock and the clock references of the input media stream.

5. The media processing device of claim 4, wherein the clock drift module is to filter out those average clock drift values that exceed a predefined threshold.

6. The media processing device of claim 1, wherein:
the output media stream is generated from the input media stream based on a recovered system time clock;
wherein the output clock signal is based on the recovered system time clock; and
wherein the clock adjust module is to adjust the output clock signal by adjusting the output clock signal independent of adjusting the recovered system time clock.

7. The media processing device of claim 1, wherein:
the output media stream is generated from the input media stream based on a recovered system time clock;
wherein the output clock signal is based on the recovered system time clock; and
wherein the clock adjust module is to adjust the output clock signal by adjusting the recovered system time clock based on the stream of filtered average clock drift values.

8. A method comprising:
generate an output media stream based on an input media stream;
transmitting the output media stream via a transmission interface clocked by an output clock signal;
determining a stream of average clock drift values based on differences between a recovered system time clock and clock references of the input media stream;
filtering the stream of average clock drift values using a proportional-integral-derivative (PID) controller to generate a stream of filtered average clock drift values; and
adjusting the output clock signal based on the stream of filtered average clock drift values.

9. The method of claim 8, wherein the input media stream comprises a Motion Pictures Experts Group (MPEG)-based transport stream and the clock references comprises program clock references (PCRs).

10. The method of claim 9, wherein the transmission interface comprises at least one of a digital video out (DVO) interface and an asynchronous serial interface (ASI).

11. The method of claim 8, further comprising:
determining the stream of average clock drift values as moving averages of the differences between the recovered system time clock and the clock references of the input media stream.

12. The method of claim 8, further comprising:
filtering out those average clock drift values that exceed a predefined threshold.

13. The method of claim 8, wherein:
generating the output media stream comprises generating the output media stream based on the recovered system time clock;
the output clock signal is based on the recovered system time clock; and
adjusting the output clock signal comprises adjusting the output clock signal independent of adjusting the recovered system time clock.

14. The method of claim 8, wherein:
generating the output media stream comprises generating the output media stream based on the recovered system time clock;
the output clock signal is based on the recovered system time clock; and
adjusting the output clock signal comprises adjusting the recovered system time clock based on the stream of filtered average clock drift values.

15. A media processing device comprising:
a first interface to receive an input media stream, the input media stream comprising a stream of clock references;
a second interface to transmit an output media stream based on an output clock signal, the output media stream comprising a representation of the input media stream; and
a clock synchronization controller comprising:
a proportional-integral-derivative (PM) controller to generate a stream of filtered average clock drift values based on an input stream of average clock drift values; and
a clock adjust module to adjust the output clock signal based on the stream of filtered average clock drift values.

16. The media processing device of claim 15, wherein the input media stream comprises a Motion Pictures Experts Group (MPEG)-based transport stream and the clock references comprises program clock references (PCRs).

17. The media processing device of claim 16, wherein the second interface comprises at least one of a digital video out (DVO) interface and an asynchronous serial interface (ASI).

18. The media processing device of claim 15, wherein the input stream of average clock drift values comprises a stream of moving averages of the differences between a recovered system time clock and the clock references of the input media stream.

19. The media processing device of claim 18, further comprising:
a low pass filter to filter out those average clock drift values that exhibit a change from a corresponding preceding clock drift value that exceeds a predefined threshold.

20. The media processing device of claim 15, wherein the clock adjust module is to adjust the output clock signal by adjusting a recovered system time clock.
